(19) United States
(12) Patent Application Publication
(10) Pub. No.: US 2003/0051742 A1
(43) Pub. Date: Mar. 20, 2003

(54) Method and apparatus for treating a substrate with an ozone-solvent solution II

(76) Inventor: David G. Boyers, Los Altos, CA (US)

Correspondence Address: Joseph H. Smith, 4410 Casa Madeira Lane, San Jose, CA, 95127, US

(21) Appl. No.: 10/126,073

(22) Filed: Apr. 19, 2002

Related U.S. Application Data
(60) Provisional application No. 60/285,483, filed on Apr. 19, 2001.

(51) Int. Cl. B08B 3/00

(52) U.S. Cl. 134/30

(57) ABSTRACT

This invention concerns a method for treating a material on a substrate. It comprises the steps of a) forming an ozone-solvent solution at a first temperature; and b) reacting the ozone-solvent solution with the material at a second temperature, wherein the first temperature is lower than the second temperature, the lower first temperature facilitating an increased concentration of dissolved ozone in the solvent, the higher second temperature facilitating an increased reaction rate between the ozone-solvent solution and the material. After step b) the material is then rinsed (step c) with a first rinse solution. Then, after step c) the ozone-solvent solution is reacted with the material at a third temperature (step d) which is higher than the first temperature. Exposure of the substrate to the ozone-solvent solution and the rinse solution may be carried out a number of times. The invention applies to a number of substrates including semiconductor wafers, flat panel displays and the like. Typical rinse solutions include water, DI water, ultra-pure water, DI water mixed with a base, DI water mixed with an acid, DI water mixed with a process compatible detergent or surfactant, isopropyl alcohol (IPA), DI water mixed with IPA, and mixtures of one of more low molecular weight alcohols and water.

### CROSS REFERENCE TO RELATED APPLICATIONS

This invention claims priority from U.S. Provisional Patent Application 60/285,483 filed Apr. 19, 2001 and is related to U.S. patent application Ser. No. 09/693,012, filed Oct. 19, 2000, which is incorporated herein by reference.

### BACKGROUND—FIELD OF INVENTION

This invention presents a method for treating materials using an ozone-solvent solution. The method may be used for removing photoresist, post ash photoresist residue, post-etch residue, and other organic materials from semiconductor wafers, flat panel display substrates, and the like at high speed using a solution of ozone gas dissolved in a solvent.

### SUMMARY OF INVENTION

In the general case, this invention concerns a method for treating a material on a substrate. It comprises the steps of a) forming an ozone-solvent solution at a first temperature; and b) reacting the ozone-solvent solution with the material at a second temperature, wherein the first temperature is lower than the second temperature, the lower first temperature facilitating an increased concentration of dissolved ozone in the solvent, the higher second temperature facilitating an increased reaction rate between the ozone-solvent solution and the material. After step b) the material is then rinsed (step c) with a first rinse solution. Then, after step c) the ozone-solvent solution is reacted with the material at a third temperature (step d) which is higher than the first temperature. Exposure of the substrate to the ozone-solvent solution and the rinse solution may be carried out a number of times.

Several features of this invention are very useful. For example:

different injected chemicals may be added to the ozone-water solution during different phases of the materials processing cycle. This provides a method for oxidizing materials using a solution of ozone gas dissolved in water which may include a means to select the mix of chemical(s) that are dispensed onto the surface of the materials to be oxidized during a given phase of the materials processing cycle.

DI water and other chemicals may be introduced in lieu of the ozone-water solution during different phases of the materials processing cycle. This provides a method for oxidizing materials using a solution of ozone gas dissolved in water which may include a means for injecting chemicals or DI water in lieu of the ozone-water solution and thereby provide a means to selectively dispense chemicals or DI water onto the surface of the materials to be oxidized during a given phase materials processing cycle.

readily integrated with a spin rinse and spin dry step. This provides a method for removing photoresist, post ash photoresist residue, post-etch residue, and other organic materials from semiconductor wafers, flat panel display substrates, and the like which can be readily integrated with a spin rinse and spin dry step provides the basis of a dry-in dry-out cleaning process.

The present invention includes two features which are advantageous: 1) different injected chemicals may be added to the ozone-water solution during different phases of the materials processing cycle, and 2) DI water and other chemicals may be introduced in lieu of the ozone-water solution during different phases of the materials processing cycle. In one embodiment of the invention we have shown that the introduction of a relatively short DI water rinse at selected intervals during the cycle can shorten the time required to remove an organic film such as photoresist from a semiconductor wafer or other substrate. For example, an ozone-water solution, and more generally, an ozone-solvent solution, can be applied to a substrate in a spin processing configuration for a duration of 20 seconds. Once the ozone-solvent solvent solution dispense is halted, then the substrate may be rinsed at a relatively high flow rate with room temperature or heated DI water for 5 seconds for example. The ozone-water-solution-etch/DI-rinse process may be repeated several times until the desired degree of film removal is achieved. The final rinse either may be the same duration and temperature as the intermediate rinses, or may be of a different duration and/or at a different temperature. In any case the time to remove the film can less than that which can be achieved without the use of intermediate rinse steps. The intermediate rinse steps are believed to enhance the etch rate by removing reaction products from the reaction site. It is believed that these reaction products may be short chain resist fragments.

### BRIEF DESCRIPTION OF DRAWING

FIG. 1 illustrates a block diagram of a method of processing semiconductor wafers with a single-wafer spin processor.

### DETAILED DESCRIPTION OF THE PREFERRED EMBODIMENTS

Materials Processing Method with a Spin Processor

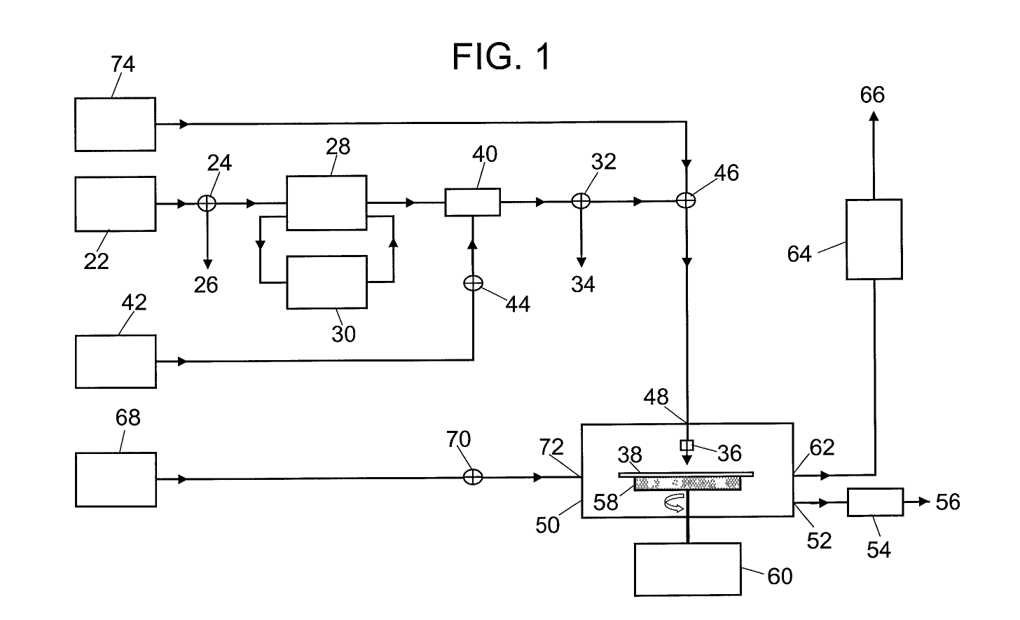

Description—FIG. 1

One method for applying the ozone-water solution to semiconductor substrates and the like is to apply the ozone-water solution to the surface of the substrate while spinning the substrate about an axis at a relatively high (1,000 to 4,000 rpm) rotational speed. The use of a this method for applying the ozone-water solution to semiconductor substrates and the like provides for a higher mass transport rate M than can be achieved by immersion techniques. With reference to FIG. 1, an ozonated water supply 22 is connected through a length of tubing to the common input of a three-way valve 24. The one outlet of three-way valve 24 is connected through a length of tubing to the cold process fluid inlet of a heat exchanger 28. The other outlet of three-way valve 24 is connected through a length of tubing to the facility drain-reclaim 26 for the ozone-water solution. The heated working fluid outlet of a recirculating heating unit 30 is connected through a length of tubing to the heated working fluid inlet of heat exchanger 28. The heated working fluid outlet of heat exchanger 28 is connected through a length of tubing to the working fluid return of recirculating heating unit 30. The heated process fluid outlet of heat exchanger 28 is connected through a short length of tubing to the inlet of chemical injector/mixer 40. The outlet of an injected chemical supply 42 is connected to the inlet of two-way valve 44. The outlet of valve 44 is connected to the chemical injection port of chemical injector/mixer 40. The outlet of chemical injector/mixer 40 is connected to the common inlet port of three-way valve 32. The one outlet of three-way valve 32 is connected through a short length to one inlet of a three-way valve etch/rinse valve 46. The common outlet of three-way etch/rinse valve 46 is connected through a short length of tubing to the process fluid inlet 48 to a dispense nozzle 36 located in a gas tight materials processing module 50. In the preferred embodiment the materials processing module 50 is fitted with a lid with a gas tight seal (not shown). The sealed materials processing module serves to contain any ozone gas that is released from solution at the point of application. A pressurized DI water rinse supply 74 is connected through a length of tubing to the other inlet of port of the three-way etch/rinse valve 46. Pressurized DI water rinse supply 74 typically comprises a pressurized source of DI water connected though a liquid pressure regulator and a liquid flow controller and liquid particulate filter. The dispense nozzle 36 is spaced a relatively short distance (typically 0.5 to 10 cm) from the surface of the material 38 to be oxidized, cleaned, etched, or processed. The other outlet of three-way valve 32 is connected through a length of tubing to the facility drain-reclaim 34 for the heated ozone-water solution.

A process fluid drain outlet port 52 of the materials processing module 50 is connected through a short length of tubing to the inlet of liquid trap 54. When the ozone-water solution is dispensed onto the surface of the substrate at a given flow rate, the gas displaced from the housing may exit at approximately the same flow rate with a relatively small pressure drop. This insures that the pressure in the housing does not rise during the dispense cycle. The outlet of liquid trap 54 is connected by a length of tubing to the facility drain/reclaim 56 for process module liquid effluent. The wafer or substrate or the like is held by a spinner chuck 58. The chuck 58 may hold the wafer or substrate or the like (the material 38 to be oxidized, cleaned, etched, or processed) by the use of vacuum, edge clamps, or other means well known to those skilled in the art. The spinner chuck 58 is connected by a shaft or other means to wafer spinner motor 60. The motor, typically controlled by a microprocessor, can be programmed to accelerate the wafer or substrate or the like at a predetermined rate from zero rpm to a predetermined rpm, hold that rpm for a specified period of time, then decelerate at a predetermined rate to back to zero. Alternatively, the motor may be programmed to successively spin at several different rpm values chosen for different portions of the materials processing cycle. An ozone off-gas outlet port 62 is connected through a length of tubing to the inlet to an ozone catalytic unit 64. The outlet of ozone catalytic unit 64 is connected through a length of tubing to a facility exhaust vent 66. The diameter of the vent line and flow capacity of the ozone catalytic unit 64 is chosen so that the vent line is non-back pressuring. In the preferred embodiment the ozone destruction unit 64 is of the catalytic type filled with a catalyst such as Carulyte 200 (Carus Corporation). Since the waste ozone gas entering the catalyst unit contains water vapor, one may heat the catalyst unit with a heat tape and temperature controller to about 50 degree C. to prevent moisture condensation on the catalyst. The increased temperature also serves to increase the performance of the catalyst. The catalyst unit is sized to provide a sufficient residence time to convert the high concentration waste ozone off-gas to oxygen. The higher the waste gas flow rate, the larger the catalyst volume must be to achieve the conversion. The required residence time can be obtained from the catalyst supplier. Alternatively, the ozone destruction unit 64 can be thermal destruction unit in which the ozone gas-oxygen mixture is decomposed back to oxygen by raising the temperature of the waste ozone gas to about 300 degree C. A pressurized nitrogen purge gas supply 68 is connected through a length of tubing to the inlet port of a two-way valve purge valve 70. The outlet port of the two-way gas purge valve 70 is connected to a purge-gas inlet 72 to the materials processing module 50. Pressurized nitrogen purge supply 68 typically comprises a pressurized source of nitrogen connected though a gas pressure regulator and a gas flow controller and gas particulate filter.

In a single wafer processing embodiment one can use a single wafer spinner such as the all Teflon microprocessor controlled wafer spinner made by Laurell in which the spinner has been fitted with a gas tight lid seal. The Laurell spinner model WS400-6TFM/Lite is all Teflon and designed to accommodate wafers up to 150 mm diameter. The spinner acceleration rate, deceleration rate, and rpm can be set and controlled between 100 RPM and 6000 RPM. The spinner can be upgraded with a valve control option that enables the spinner microprocessor to control up to eight valves. This enables precise automated control of the purge to waste, etch dispense, and DI rinse dispense cycle times. Laurell makes spinners to accommodate 200 mm diameter wafers, 300 mm diameter wafers, and other substrates sizes and shapes.

Alternative Means for Applying Ozone-Water Solution to the Substrate

The application of the ozone-water-other chemicals solution to the surface or surfaces of the material to be processed can be accomplished in a number of different ways. In one embodiment, the solution can be applied to the center of the wafer through a single solid stream nozzle 36 with an inside diameter of about 6 mm positioned to apply a flow of water to the wafer at the center. In a second embodiment the solution can be successively applied to different positions between the center and edge of the wafer. In this second embodiment the ozone-water solution can be flowed through a nozzle which can be successively positioned at different locations from the center to the edge of the wafer or from the edge to the center of the wafer. The dwell time at each position can be controlled to reduce the radial variation in the etch rate or cleaning rate or oxidation rate over the duration of the materials processing cycle. In a third embodiment the solution can be applied the surface of the wafer with multiple nozzles (not shown). In a fourth embodiment, one or more nozzles may be mounted onto one or more rotating spray arms (not shown) positioned to apply the solution to one or more surfaces of the material to be oxidized. The ozone-water-other chemicals solution can be applied to the surface or surfaces of the material to be processed by other means familiar to those skilled in the art.

Alternative Means for Applying DI Rinse Water to the Substrate

In an alternative embodiment the DI rinse water may be applied to the substrate with a separate set of one or more rinse nozzles (not shown). Rinse nozzles may be chosen for optimum rinse performance at a predetermined rinse flow rate and the nozzles may be positioned to rinse one or more surfaces of the substrate.

Operation—FIG. 1

A preferred technique for applying the ozone-water solution to semiconductor substrates and the like is to apply the ozone-water solution to the surface of the substrate while spinning the substrate about an axis at a relatively high (1,000 to 4,000 rpm) rotational speed. The use of a this method for applying the ozone-water solution to semiconductor substrates and the like provides for a higher mass transport rate M than can be achieved by immersion techniques. One use of the preferred embodiments is for the removal of photoresist and post etch residue from semiconductor wafers and the like. Let us describe the operation for a typical photoresist or post etch residue removal application. With reference to FIG. 1, ozononated water supply 22 supplies an ozonated water formed by dissolving ozone gas at a gas phase concentration of 240 mg/L and pressure of 14.5 psia (1 bar) into DI water chilled to a temperature of about 8 degree C. The ozonated water supply delivers the chilled ozone gas-water solution at a dissolved concentration of about 90 mg/L and at a flow rate of 2.7 Liter/min through three way purge valve 24, through a heater 28 where the solution temperature is increased to about 50 degree C., through chemical injector/mixer 40, through three-way purge valve 32, through three-way etch/rinse valve 46, through materials-processing-module inlet 48, through dispense nozzle 36 where the heated ozone-water solution is applied to the center of a semiconductor wafer 38 spinning at about 3500 to 4,000 rpm. In this embodiment shown in FIG. 1 the heater is a heat exchanger. In another embodiment that heater 28 may be a direct heater which may be heated by an number of means including resistance heating, induction heating, convection heating, microwave heating, or radiant heating. In another embodiment the heater 28 may be an injector or eductor with the relatively low temperature ozone-water solution entering the motive flow inlet, high purity steam formed from DI water introduced into the suction inlet, and the heated ozone water solution exiting from the injector or eductor outlet. Under these conditions the inventors have shown that the dissolved ozone concentration downstream of the point-of-use heater is approximately 75 mg/L, more than 80 percent of the concentration at the inlet of the point-of-use heater. In general, what is desired is that the concentration at the higher temperature is higher than the equilibrium concentration at that higher temperature. The ozone-water solution traverses the surface of the wafer from the point of application to the edge of the wafer and enters the process fluid outlet of the materials-processing-module where the ozone-water solution and other liquid effluents from the process are carried through a trap to facility drain 56. The trap prevents back flow of an gases from the facility drain reclaim reservoir. The nitrogen purge supply flows dry filtered nitrogen gas, or another suitable gas, at a flow rate of about 0.5 L/min, through the two-way nitrogen purge valve 70, to the inlet of the materials-processing-module 72. The nitrogen gas assists in the removal of any ozone gas that leaves the ozone-water solution inside the materials-processing-module and provides a nitrogen blanketed processing environment. The ozone off-gas, nitrogen, and other waste gases from the process, exit from the materials-processing-module at outlet port 62, pass through the catalyst unit 64 where the waste ozone gas is converted to oxygen before exiting to the facility exhaust vent 66. The period during which the ozone-water solution is applied to the spinning substrate can be designated as the duration of the etch clean cycle. Once the etch cycle is completed, the three way purge valve 32 can be set to direct the flow of the heated ozone-water solution to the facility drain/reclaim 34 for the heated ozone-water solution and the three-way etch/rinse valve 46 can be placed in the rinse position to allow the rinse water to flow to the materials-processing-module. DI water can then flow from the pressurized DI water supply through the three way valve 46, through materials-processing-module inlet 48, through dispense nozzle 36 where the DI water solution is applied to the center of a semiconductor wafer 38 spinning at about 3500 to 4,000 rpm. The period during which the DI rinse water is applied to the spinning substrate 38 can be designated as the duration of the rinse cycle. Once the rinse cycle is completed, the three-way etch rinse valve 46 can be returned to the etch position while the three-way purge valve 32 remains set to direct the flow of the heated ozone-water solution to the facility drain/reclaim 34 so that all liquid flows to materials-processing-module are off and the wafer can be spun dry. The period during which all liquid flows to the materials processing module are off and the substrate is spinning can be designated as the duration of the spin dry cycle. The spin RPM and duration of each cycle can be set to a predetermined value for a particular process application.

Example Process Conditions for Photoresist Removal and Post Etch Residue Removal

A typical wafer spin processing sequence my include spin etch or cleaning or oxidation cycle, a spin rinse cycle, and a spin dry cycle. Example process conditions for photoresist removal and post etch residue removal with 150 mm diameter wafers in a single wafer spin processing configuration are summarized in Table 1 below.

TABLE 1
Example Process Conditions for Photoresist Removal And Post
Etch Residue Removal- Single Wafer Processing Configuration -
150 mm Diameter Wafers- No Intermediate Rinse

| | |
|---|---|
| ETCH CLEAN | |
| Dissolved Ozone Concentration | 70 to 210 mg/L |
| (mg/L)/(millimoles/liter) | (1.5 to 4.5 millimoles/L) |
| Hydroxyl Radical Scavenger | Carbonate, Bicarbonate, |
| | Phosphate, Acetate |
| Hydroxy Radical Scavenger | 5 to 10 × dissolved |
| Concentration (millimoles/liter) | ozone concentration |
| pH | 6.5 to 7.5 |
| Ozone-Water Solution Temperature at | 40 to 60 |
| the point of application (° C.) | |
| Spin Etch Speed (RPM) | 2,000 to 4,000 |
| Ozone-Water Solution Flow Rate | 1.0 to 3.0 |
| (L/min) | |
| Etch Duration (min) | 0.5 to 6.0 |
| RINSE | |
| DI Rinse Temperature (° C.) | 20 |
| Spin Rinse Speed (RPM) | 2,000 to 4,000 |
| DI Rinse Flow Rate (L/min) | 0.5 to 1.0 |
| DI Rinse Duration (min) | 0.33 to 1.0 |
| DRY | |
| Spin Dry Speed (RPM) | 2,000 to 4,000 |
| Dry Duration (mm) | 0.33 to 1.0 |

These process conditions are typical for this type of application. However, process conditions outside the range of values presented in the Table 1 above can also provide satisfactory performance for this and other applications and wafer processing configurations. For example, batch wafer spinning configurations in which two to four cassettes of wafers are processed at one time typically operate at a lower RPM and lower etch flow rate per wafer. The RPM for a batch spinner is typically in the range of 500 to 1500 RPM. The total etch chemistry flow rate for a batch wafer spinner is typically in the range of 10 to 20 liters/minute. The lower RPM and lower flow rates will yield a lower mass transport rate and lower etch rate. The temperature at which the etch rate will become mass transport limited will be lower since the mass transport rate is lower as discussed earlier.

In one embodiment of the invention we have shown that the introduction of a relatively short DI water rinse at selected intervals during the cycle can shorten the time required to remove an organic film such as photoresist from a semiconductor wafer or other substrate. For example, an ozone-water solution, and more generally, an ozone-solvent solution, can be applied to a substrate in a spin processing configuration for a duration of 20 seconds. Once the ozone-solvent solvent solution dispense is halted, then the substrate may be rinsed at a relatively high flow rate with room temperature or heated DI water for 5 seconds for example. An elevated temperature rinse is generally preferred over a room temperature rinse because of the increased solubility of the reaction products at elevated temperatures improves the rinse effectiveness. The elevated temperature rinse is also generally preferred over a room temperature rinse because the higher temperature speeds the rate of drying. This can be helpful in the case of the final rinse prior to the wafer drying step. The ozone-water-solution-etch/DI-water-rinse process may be repeated several times until the desired degree of film removal is achieved. The final rinse may be the same duration and temperature as the intermediate rinses or may be of a different duration and at a different temperature. In any case the time to remove the film can less than that which can be achieved without the use of intermediate rinse steps. The intermediate rinse steps area believed to enhance the etch rate by removing reaction products from the reaction site. Example conditions are summarized in Table 2.

TABLE 2
Example Process Conditions for Photoresist Removal And Post
Etch Residue Removal-Single Wafer Processing Configuration -
150 mm Diameter Wafers - w/Intermediate Rinses.

| | |
|---|---|
| ETCH CLEAN | |
| Dissolved Ozone Concentration | 70 to 210 mg/L |
| (mg/L)/(millimoles/liter) | (1.5 to 4.5 millimoles/L) |
| Hydroxyl Radical Scavenger | Carbonate, Bicarbonate, |
| | Phosphate, Acetate |
| Hydroxy Radical Scavenger | 5 to 10 × dissolved |
| Concentration (millimoles/liter) | ozone concentration |
| pH | 6.5 to 7.5 |
| Ozone-Water Solution Temperature at | 40 to 60 |
| the point of application (° C.) | |
| Spin Etch Speed (RPM) | 2,000 to 4,000 |
| Ozone-Water Soln. Flow Rate (L/min) | 1.0 to 3.0 |
| Intermediate Etch Duration (secs) | 10 to 30 |
| Total Etch Duration (min) | 0.5 to 6.0 |
| Intermediate RINSE | |
| Intermediate DI Rinse Temp. (° C.) | 20 to 85 degree C |
| Intermediate Spin Rinse Speed (RPM) | 2,000 to 4,000 |
| Intermediate DI Rinse Flow Rate | 0.5 to 5.0 |
| (L/min) | |
| Intermediate DI Rinse Duration (secs) | 1 to 10 |
| Final RINSE | |
| Final DI Rinse Temperature (° C.) | 20 to 85 degree C |
| Final Spin Rinse Speed (RPM) | 2,000 to 4,000 |
| Final DI Rinse Flow Rate (L/min) | 0.5 to 5.0 |
| Final DI Rinse Duration (secs) | 1 to 60 |
| DRY | |
| Spin Dry Speed (RPM) | 2,000 to 4,000 |
| Dry Duration (min) | 0.1 to 1.0 |

TABLE 3
The measured etch rate when ozone is dissolved in water at a lower temperature to
produce a high dissolved concentration, then passed at given flow rate though a
point of use heater, and applied at a higher temperature to the center of spinning
wafer. The wafer is coated with a layer of hard baked I-line positive photoresist.
The highest etch rate is achieved at the center of the wafer and the lowest etch
rate is achieved at the edge of the wafer. Etch rate measured for a 20 second
removal period and for a 70 second removal period to full removal. Flow Rate:
2.6 L/min; Wafer Spin RPM: 4000, Initial I-line Resist Thickness: 11,700 A°.
The predicted etch rate and clearing time with one intermediate rinse of 5
second duration is shown in the last row of the table.

| Dissolved | Dissolved | Applied | Removal | Max Etch | Min Etch | |
|---|---|---|---|---|---|---|
| Ozone Conc. | Temp. | Temp. | Period | Rate | Rate | Clear Time |
| (mg/L) | (deg C) | (deg C) | (secs) | (A°/min) | (A°/min) | (secs) |
| 92.5 | 8.0 | 41.0 | 20 | 24,504 | 16,524 | 43 |
| | | | | | | (calculated) |
| 92.5 | 7.4 | 41.0 | 70 | NA | 10,029 | 70 |
| | | | | | (calc.) | (measured) |
| 92.5 | 7.4 | 41.0 | NA | 24,504 | 16,524 | 48 |
| | | | | predicted | predicted | (predicted) |

We have confirmed the benefit of intermediate rinsing in our laboratory by performing the following experiment. We processed a 150 mm diameter coated with 12,000 A° of I-line resist for 20 seconds under conditions specified in row 1 of Table 3 above. We then rinsed the wafer with room temperature DI water and spin dried the wafer. This resulted in partial removal of the resist layer. We then processed the same wafer for a second 20 second period under the conditions specified in row 1 of Table 3 above. We then final rinsed the wafer with room temperature DI water and spin dried the wafer. This resulted in full removal of the resist layer. This demonstrates that with one intermediate rinsing and a final rinse that the entire 12,000 A° thick layer of resist could be removed with only 40 seconds of “etching” by the ozone-water solution. The rinse duration may be made very short by using an elevated rinse temperature and a high pressure and/or high flow rate rinse. The interval between rinsing may be made longer or shorter and optimized for the particular organic layer being removed. In another embodiment the etch solution dispense may not be halted during the rinse period. In this case the rinse and etch solutions may be applied to the substrate concurrently during all or a portion of the cycle.

The rinse solution may be applied to one or more surfaces of the substrate using the same application means as used to apply the ozone-solvent solution or the rinse solution may be applied to one or more surfaces of the substrate using a different application means than that used to apply the ozone-solvent solution.

The rinse solution may be pure DI water; the rinse solution may be pure DI water mixed with an acid; the rinse solution may be pure DI water mixed with a base; the rinse solution may be pure DI water mixed with a process compatible detergent and/or surfactant. The rinse solution may be isopropyl alcohol (IPA) or an IPA-water solution; IPA based rinsing can also aid drying since IPA acts as an effective drying agent; low molecular weight alcohols other than IPA, or mixtures of low molecular weight alcohols, may be used; they may be used alone or in solution with DI water. The composition and temperature of the intermediate rinse solution may be different from that of the final rinse solution.

TABLE 4
The measured etch rate when ozone is dissolved in water at a given temperature and
given concentration and applied at a given flow rate though a point of use heater
and through a dispense nozzle at a higher temperature to the center of spinning
wafer coated with a layer of hard baked DUV positive photoresist. The highest
etch rate is achieved at the center of the wafer and the lowest etch rate is
achieved at the edge of the wafer. Etch rate measured for a 20 second removal
period and for a 90 second removal period to full removal. Flow Rate: 2.6 L/min;
Wafer Spin RPM: 4000, Initial DUV Resist Thickness: 9,800 A°. The predicted
etch rate and clearing time with two intermediate rinses of 5 second duration is
shown in the last row of the table.

| Dissolved | Dissolved | Applied | Removal | Max Etch | Min Etch | |
|---|---|---|---|---|---|---|
| Ozone Conc. | Temp. | Temp. | Period | Rate | Rate | Clear Time |
| (mg/L) | (deg C) | (deg C) | (secs) | (A°/min) | (A°/min) | (secs) |
| 92.5 | 8.0 | 41.0 | 20 | 16,725 | 10,590 | 56 |
| | | | | | | (calculated) |
| 92.5 | 7.1 | 41.0 | 90 | NA | 6,533 | 90 |
| | | | | | | (measured) |
| 92.5 | 7.1 | 41.0 | NA | 16,725 | 10,590 | 66 |
| | | | | | | (predicted) |

GENERAL COMMENTS

In many instances in the above description of the preferred embodiments any elements that are between the inlet of the heater 28 and the dispense nozzle 36 are said to be connected by a short length of tubing. The requirement is actually the volume of the tubing not the length because, at a given flow rate, the time delay between the time the ozone-water solution is heated, transported through the connecting tubing to the point of application of the material to be oxidized. When we say short length of tubing we are really saying small volume length of tubing. The tubing length and internal diameter is chosen such that the total time is such that the dissolved ozone concentration does not fall by more that a predetermined amount at a chosen process temperature. In many early embodiments constructed by the inventors the tubing was Teflon with an inside diameter of between 0.125 inches to 0.180 inches. The tubing connecting the various elements was between 2 to 10 inches long such that the total residence time in the heater and interconnecting tubing was less than 5 seconds for example at a particular flow rate through the point-of-use heater.

1. A method for treating a material on a substrate, comprising:
a) forming an ozone-solvent solution at a first temperature;
b) reacting said ozone-solvent solution with the material at a second temperature;
wherein said first temperature is lower than said second temperature, said lower first temperature facilitating an increased concentration of dissolved ozone in the solvent, said higher second temperature facilitating an increased reaction rate between the ozone-solvent solution and the material;
c) rinsing the substrate with a first rinse solution after step b);
d) reacting said ozone-solvent solution with the material at a third temperature which is higher than said first temperature after step c).

2. The method of claim 1, wherein the material is selected from the group consisting of photoresist, post-etch resist residue, anti-reflective coatings, and organic contamination.

3. The method of claim 1 wherein the third temperature is the same as the second temperature.

4. The method of claim 1 further comprising step e) rinsing the substrate with a second rinse solution after step d).

5. The method of claim 4 wherein said second rinse solution is the same as said first rinse solution.

6. The method of claim 4 further comprising step f) reacting said ozone-solvent solution with the material at a fourth temperature after step e).

7. The method of claim 6 wherein the fourth temperature is the same as the second temperature.

8. The method of claim 6 wherein step e) and step f) are repeated in sequence one or more times.

9. The method of claim 1 wherein the step b) is performed by quickly heating said ozone-solvent solution from said first temperature to said second temperature to create a supersaturated solution of ozone in the solvent at said second temperature, wherein said ozone-solvent solution has a much higher ozone concentration than if said ozone-solvent solution had been heated slowly under equilibrium conditions.

10. The method of claim 9 wherein step b) further comprises the step of spraying said supersaturated solution onto said material.

11. The method of claim 10 wherein the step of spraying comprises ejecting said supersaturated solution through at least one nozzle.

12. The method of claim 1 wherein step b) comprises spraying said ozone-solvent solution through at least one nozzle onto said material.

13. The method of claim 1 wherein said first rinse solution has at least one constituent selected from the group consisting of water, DI water, ultra-pure water, DI water mixed with a base, DI water mixed with an acid, DI water mixed with a process compatible detergent or surfactant, isopropyl alcohol (IPA), DI water mixed with IPA, mixtures of one of more low molecular weight alcohols and water.

14. The method of claim 1 wherein said first rinse solution is selected from the group consisting of water, DI water, ultra-pure water, DI water mixed with a base, DI water mixed with an acid, DI water mixed with a process compatible detergent or surfactant, isopropyl alcohol (IPA), DI water mixed with IPA, mixtures of one of more low molecular weight alcohols and water.

15. The method of claim 4 wherein said second rinse solution is selected from the group consisting of water, DI water, ultra-pure water, DI water mixed with a base, DI water mixed with an acid, DI water mixed with a process compatible detergent or surfactant, isopropyl alcohol (IPA), DI water mixed with IPA, mixtures of one of more low molecular weight alcohols and water.

16. The method of claim 1 further comprising the step of drying the substrate after step c).

17. The method of claim 1 further comprising the step of drying the substrate after step d).

18. The method of claim 4 further comprising the step of drying the substrate after step e).

19. The method of claim 6 further comprising the step of drying the substrate a plurality of times.

20. The method of claim 1, wherein said ozone-solvent solution is heated from said first temperature to the said second temperature and wherein said heated ozone-solvent solution is applied to the material within a time period after heat is first applied to said ozone-solvent solution to minimize a decrease in concentration of dissolved ozone in the ozone-solvent solution.
